(19) United States
(12) Patent Application Publication
(10) Pub. No.: US 2024/0227814 A1
(43) Pub. Date: Jul. 11, 2024

(54) SYSTEMS AND TECHNIQUES FOR DETERMINING DISSIPATION BOUNDARIES FOR AUTONOMOUS VEHICLES

(71) Applicant: GM Cruise Holdings LLC, San Francisco, CA (US)

(72) Inventors: Akshay Rangesh, Mountain View, CA (US); Chingiz Tairbekov, San Francisco, CA (US); Wudao Ling, San Francisco, CA (US)

(21) Appl. No.: 18/094,862

(22) Filed: Jan. 9, 2023

(51) Int. Cl. B60W 40/02; G06V 20/56

(52) U.S. Cl. CPC B60W 40/02; G06V 20/56; B60W 2552/00; B60W 2554/402; B60W 2554/4041

(57) ABSTRACT

Systems and techniques are disclosed for determining an autonomous vehicle (AV) boundary at which an occluded object is realized. An example method can include generating, based on sensor data collected in a driving environment, a first set of data representing the driving environment; generating, based on the sensor data, a second set of data representing an occluded scene element in the driving environment; generating, based on the sensor data, a third set of data representing an occluding object that at least partially occludes the occluded scene element from a view and/or perspective of one or more sensors of an AV in the driving environment; and based on the first, second, and third set of data and a trajectory of the AV, determine a dissipation boundary associated with the occluded scene element, the dissipation boundary comprising a location(s) where the AV is predicted to perceive the occluded scene element.

### BACKGROUND

### 1. Technical Field

The present disclosure generally relates to handling occluded objects that may potentially intersect with a trajectory of an autonomous vehicle. For example, aspects of the present disclosure relate to techniques and systems for determining a boundary at which a hypothetical occluded scene element is determined to exist or not exist based on multiple data sources.

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions that are conventionally performed by human drivers, such as performing navigation and routing tasks necessary to provide a safe and efficient transportation. Such tasks may involve collecting and processing large quantities of data from various sensors of an AV such as, for example and without limitation, camera sensors, radio detection and ranging (RADAR) sensors, inertial measurement units (IMUs), and/or light detection and ranging (LiDAR) sensors, among others.

### BRIEF DESCRIPTION OF THE DRAWINGS

Illustrative embodiments of the present application are described in detail below with reference to the following figures:

FIG. 1 illustrates an example system environment that can be used to facilitate autonomous vehicle (AV) navigation and routing operations, according to some examples of the present disclosure;

FIG. 2 illustrates an example of a neural network that can be used to determine a dissipation boundary, according to some examples of the present disclosure;

FIG. 3 illustrates an example system for determining a dissipation point associated with an occluded scene element, according to some examples of the present disclosure;

FIG. 4 illustrates an example system for determining a dissipation boundary, according to some examples of the present disclosure;

FIG. 5 illustrates an example process for determining a dissipation boundary for a scene, according to some examples of the present disclosure;

FIG. 6 illustrates an example process for determining a dissipation boundary, according to some examples of the present disclosure; and

FIG. 7 illustrates an example processor-based system with which some aspects of the subject technology can be implemented, according to some aspects of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Autonomous vehicles (AVs), also known as self-driving cars, driverless vehicles, and robotic vehicles, are vehicles that use sensors to sense the environment and move without human input. Automation technologies enable AVs to drive on roadways and perceive the surrounding environment accurately and quickly, including obstacles, signs, road users and vehicles, traffic lights, among others. In some cases, AVs can be used to pick-up passengers and/or cargo and drive the passengers and/or cargo to selected destinations.

An AV can include various types of sensors such as, for example and without limitation, a camera sensor, a light detection and ranging (LIDAR) sensor, a radio detection and ranging (RADAR) sensor, an acoustic sensor (e.g., an ultrasonic sensor, a microphone, etc.) an inertial measurement unit (IMU), among others. The AV can use such sensors to collect data and measurements in a driving environment, which the AV can use to perform AV operations such as navigation. The sensors can provide the data and measurements to an internal computing system of the AV that can use the data and measurements to control a mechanical system of the AV, such as a vehicle propulsion system, a braking system, or a steering system.

Collisions involving at least one vehicle represent a meaningful threat to road users and can be caused by a variety of reasons such as, for example, human error, road conditions, weather conditions, events, etc. Even seasoned and/or defensive drivers can experience vehicle collisions and/or associated risks. Numerous vehicle safety technologies can be implemented by AVs and other vehicles to prevent or mitigate the risks and/or occurrences of collisions involving at least one vehicle. For example, a vehicle may implement one or more sensors to detect objects and conditions in a driving environment and trigger certain actions (e.g., vehicle maneuvers, etc.) to avoid collisions, mitigate the risk of collisions, and/or mitigate the harm of collisions.

While vehicle safety technologies can mitigate the risk of a vehicle collision, there are potential collision risks that can be caused by third parties such as pedestrians and other road users. Moreover, in many cases, the visibility of a moving target (e.g., a pedestrian, an animal, a vehicle, etc.) from the perspective of a vehicle may be limited or blocked by other objects in the scene. The lack of visibility of the moving target from the perspective of the vehicle can make it difficult for the vehicle to detect the moving target in sufficient time to avoid colliding with the moving target, and can increase the risk of a collision with the moving target.

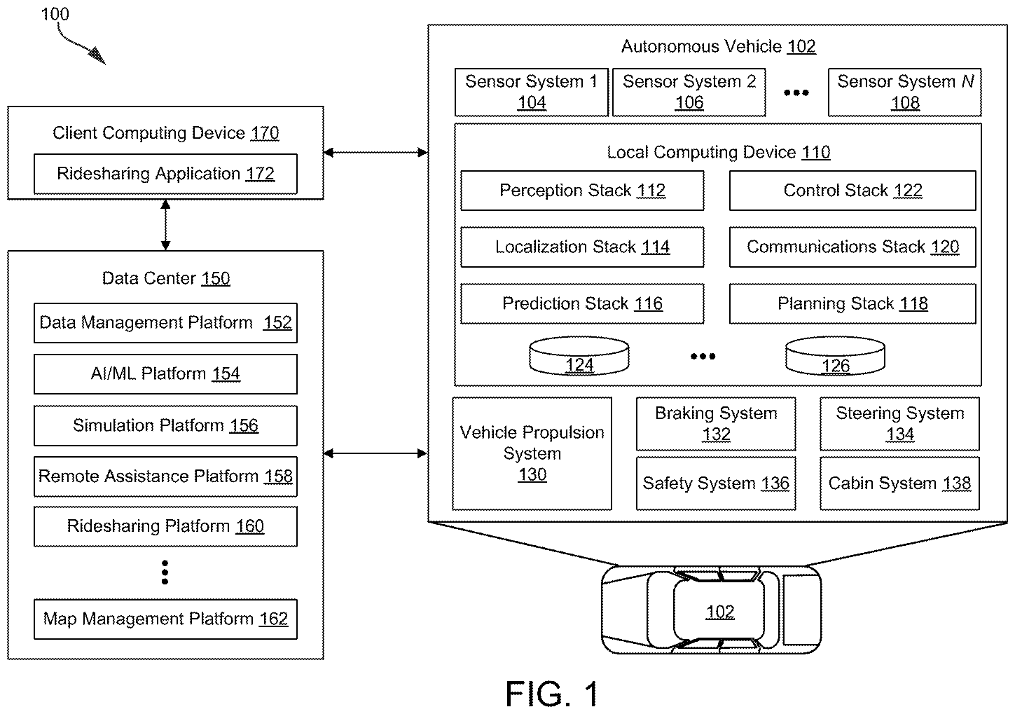

As discussed above, the sensors of an AV (e.g., sensor systems 104, 106 and 108 illustrated in FIG. 1 and described below with respect to FIG. 1) may enable the AV to sense the surrounding environment and move without human input. For example, if there is a pedestrian in front of the AV, the sensors may detect the pedestrian and inform the AV of the presence of the pedestrian so the AV can act/react as needed (e.g., apply brakes and stop or decelerate the vehicle prior to colliding with the pedestrian, switch lanes, steer the AV away from a trajectory of the pedestrian, etc.). In some cases, there may be a scene element (e.g., a pedestrian, an object, an animal, a vehicle, a robotic system/device, etc.) in an environment associated with an AV that is occluded (e.g., hidden from and/or not detected by the AV's sensor systems) by something in the environment. Such occlusion can hide the scene element from a view of one or more sensors of the AV and/or restrict an AV from sensing (e.g., via one or more sensors of the AV) a presence of the scene element. In this example, there is a risk that the scene element may suddenly appear within a trajectory of the AV, from the hidden view or occlusion (e.g., a pedestrian may move from a location occluded by an occluding object or vehicle and become visible to one or more sensors of the AV). When this happens, the AV may not have enough time to react (e.g., apply brakes to stop or decelerate the vehicle) as needed to avoid colliding with the scene element.

Described herein are systems, apparatuses, processes (also referred to as methods), and computer-readable media (collectively referred to as “systems and techniques”) for determining a point along a proposed autonomous vehicle path at which a hypothetical occluded scene element (e.g., an object, a vehicle, a pedestrian, an animal, etc.) is realized (e.g., is visible to one or more sensors of an autonomous vehicle, is determined by the autonomous vehicle to exist or not exist, etc.). In other words, for a given AV path (e.g., trajectory), there may be a point (e.g., a position along the AV path) at which a hypothetical occluded scene element that is occluded (e.g., hidden/occluded from view of one or more sensors of the AV) by an occluding object (e.g., a vehicle, a tree, a building, a traffic sign, a pedestrian, a trash can, etc.) is realized by the AV (e.g., is perceived/detected by the AV, is visible to one or more sensors of the AV, etc.). The hypothetical occluded scene element can be or include a scene element (e.g., a pedestrian, a vehicle, an animal, an object capable of moving, etc.) that has not been confirmed to exist by an AV navigating a scene associated with the scene element because, if the scene element exists, the scene element may be at a location at which the scene element is occluded (e.g., is partially or fully blocked by something from a view of one or more sensors of the AV) by another object from a view of one or more sensors of the AV. In other words, a hypothetical occluded scene element can include any scene element (e.g., a pedestrian, an animal, a robotic system/device, another vehicle, etc.) that may move and is partially or fully blocked from a view of the AV (e.g., from a view of one or more sensors of the AV).

The point at which the hypothetical occluded scene element that is occluded by an occluding object is realized may be referred to herein as a dissipation point. The dissipation point can refer to a moment in time and space where/when a hypothetical occluded scene element occluded from a view of the AV (e.g., from a view of one or more sensors of the AV) becomes visible to the AV (e.g., is perceived/detected by a perception stack of the AV). In other words, the hypothetical occluded scene element is indeed real (e.g., it exists and is present) and becomes realized (e.g., perceived/detected) by the AV. Non-limiting examples of a hypothetical occluded scene element may include an occluded pedestrian, an occluded animal, an occluded device, an occluded vehicle, an occluded object, and/or any other occluded item. One of ordinary skill in the art will appreciate additional examples of hypothetical occluded scene elements. In some aspects, an AV may determine multiple dissipation points for multiple AV paths. In other words, more than one AV path may be proposed for a given scene which may result in multiple dissipation points. As described herein, a dissipation boundary may be determined from the collection of dissipation points (e.g., connecting the dissipation points together to form a dissipation boundary).

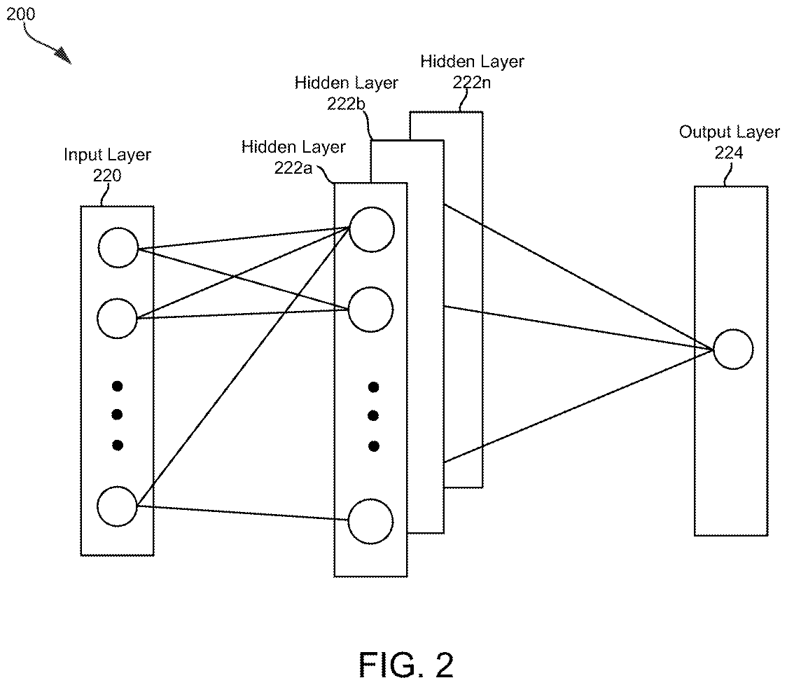

In some examples, a neural network (e.g., neural network 200 as illustrated in FIG. 2) can determine the dissipation point and/or the dissipation boundary (e.g., multiple dissipation points can determine a dissipation boundary). For example, a neural network can model the point along a proposed AV path at which a hypothetical occluded scene element is realized. In some cases, the neural network may determine the dissipation point (e.g., also dissipation boundary for multiple dissipation points) using multiple data sources such as, for example and without limitation, the proposed AV path (e.g., waypoints or discrete time samples of the AV path), a geometry of the occluding object (e.g., the size and shape of the object occluding the hypothetical scene element), a location of the occluding object, one or more characteristics of the scene (e.g., details of the scene and/or a scene map such as a location of a road, crosswalk, sidewalk, traffic lights, etc.), other scene agents (e.g., other elements or objects in the scene), etc.

Examples of the systems and techniques described herein are illustrated in FIG. 1 through FIG. 7 and described below.

FIG. 1 illustrates an example of an AV environment 100, according to some examples of the present disclosure. One of ordinary skill in the art will understand that, for the AV environment 100 and any system discussed in the present disclosure, there can be additional or fewer components in similar or alternative configurations. The illustrations and examples provided in the present disclosure are not limiting and provided for explanation purposes. Other examples may include different numbers and/or types of elements, but one of ordinary skill in the art will appreciate that such variations do not depart from the scope of the present disclosure.

In this example, the AV environment 100 includes an AV 102, a data center (also autonomous vehicle fleet management device, autonomous vehicle fleet management system, management system) 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise inertial measurement units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack 116 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal U-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, a ridesharing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the map management platform 162, and other platforms and systems. The simulation platform 156 can replicate a variety of driving environments and/or reproduce real world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridesharing platform 160 may incorporate the map viewing services into the client application 172 to enable passengers to view the AV 102 in transit en route to a pick-up or drop-off location, and so on.

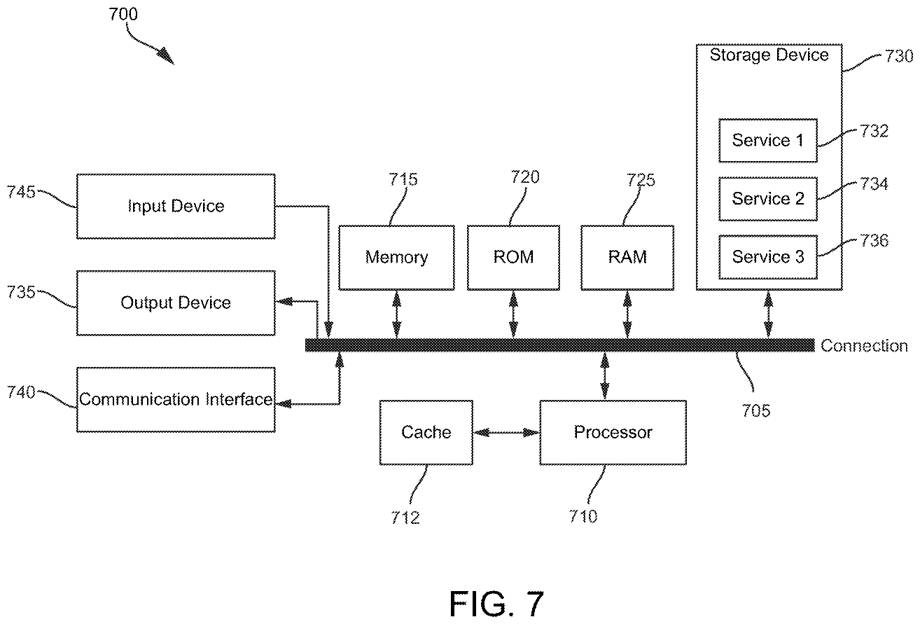

While the autonomous vehicle 102, the local computing device 110, and the autonomous vehicle environment 100 are shown to include certain systems and components, one of ordinary skill will appreciate that the autonomous vehicle 102, the local computing device 110, and/or the autonomous vehicle environment 100 can include more or fewer systems and/or components than those shown in FIG. 1. For example, the autonomous vehicle 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 7.

FIG. 2 is a diagram illustrating an example neural network 200 that can be used by the systems and techniques described herein. For example, the example neural network 200 can be used to predict and/or determine the point and/or boundary along one or more AV paths at which a hypothetical occluded scene element dissipates or is realized (e.g., the dissipation point and/or boundary). An input layer 220 can be configured to receive sensor data and/or data relating to an environment/scene surrounding an AV. The neural network 200 includes multiple hidden layers 222a, 222b, through 222n. In this example, the hidden layers 222a through 222n include “n” number of hidden layers, where “n” is an integer greater than or equal to one. The number of hidden layers can be made to include as many layers as needed for the given application. Neural network 200 also includes an output layer 224 that provides an output resulting from the processing performed by the hidden layers 222a, 222b, through 222n. In one illustrative example, the output layer 224 can generate an output indicating a dissipation point and/or a dissipation boundary associated with a hypothetical occluded scene element, as further described herein.

The neural network 200 is a multi-layer neural network of interconnected nodes. Each node can represent a piece of information. Information associated with the nodes is shared among the different layers and each layer retains information as information is processed. In some cases, the neural network 200 can include a feed-forward network, in which case there are no feedback connections where outputs of the network are fed back into itself. In some cases, the neural network 200 can include a recurrent neural network, which can have loops that allow information to be carried across nodes while reading in input.

Information can be exchanged between nodes through node-to-node interconnections between the various layers. Nodes of the input layer 220 can activate a set of nodes in the first hidden layer 222a. For example, as shown, each of the input nodes of the input layer 220 is connected to each of the nodes of the first hidden layer 222a. The nodes of the first hidden layer 222a can transform the information of each input node by applying activation functions to the input node information. The information derived from the transformation can then be passed to and can activate the nodes of the next hidden layer 222b, which can perform their own designated functions. Non-limiting example functions include convolutional, up-sampling, data transformation, and/or any other suitable functions. The output of the hidden layer 222b can then activate nodes of the next hidden layer, and so on. The output of the last hidden layer 222n can activate one or more nodes of the output layer 224, at which an output is provided. In some cases, while nodes in the neural network 200 are shown as having multiple output lines, a node can have a single output and all lines shown as being output from a node represent the same output value.

In some cases, each node or interconnection between nodes can have a weight that is a set of parameters derived from the training of the neural network 200. Once the neural network 200 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 200 to be adaptive to inputs and able to learn as more and more data is processed.

The neural network 200 can be pre-trained to process features from the data in the input layer 220 using the different hidden layers 222a, 222b, through 222n in order to generate an output via the output layer 224.

In some cases, the neural network 200 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 200 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½ (target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 200 can perform a backward pass by determining which inputs (weights) most contributed to the loss of the network, and can adjust the weights so that the loss decreases and is eventually minimized.

The neural network 200 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 200 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and/or applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

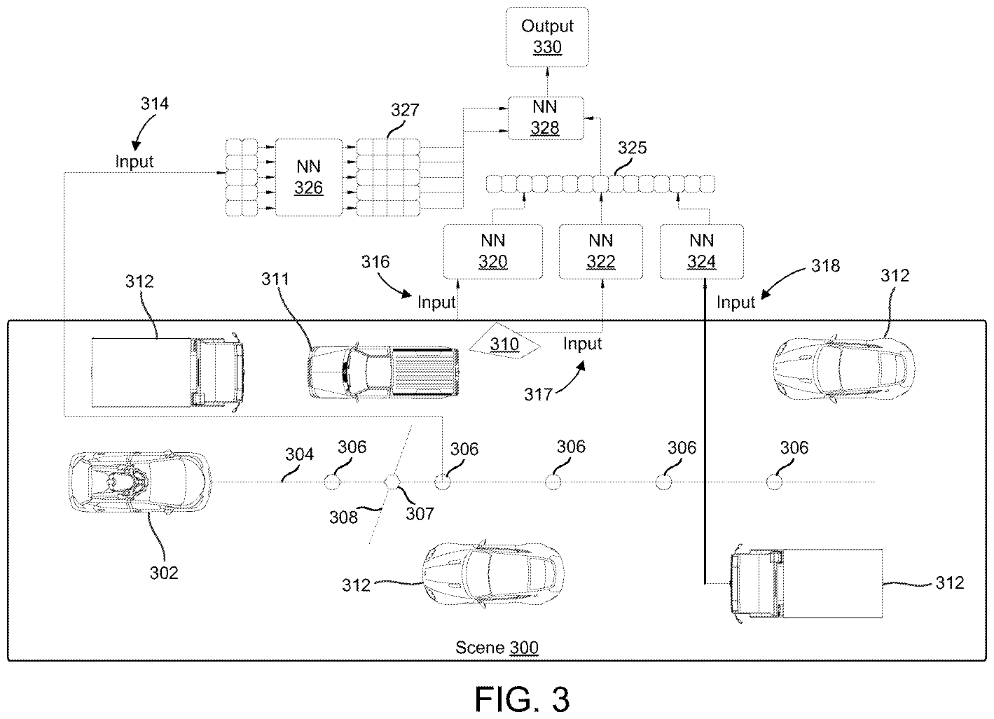

FIG. 3 is a diagram illustrating an example system for determining a dissipation point 307 associated with an occluded scene element 310 in a scene 300, according to some aspects of the present disclosure. In this example, the system includes a first neural network 320, a second neural network 322, a third neural network 324, a fourth neural network 326, and a fifth neural network 328. The first neural network 320, second neural network 322, third neural network 324, and fourth neural network 326 can process aspects of a scene 300 that, in this example, includes an AV 302, a trajectory 304 of the AV 302, waypoints 306 (also samples, discrete time samples) along the trajectory 304, a dissipation point 307, a dissipation boundary 308, an occluded scene element 310 (also occluded object, hypothetical occluded scene element, hypothetical scene element), an occluding object 311 (also an occlusion), and one or more scene agents 312.

The first neural network 320, second neural network 322, third neural network 324, fourth neural network 326, and fifth neural network 328 can each represent any type of neural network. For example, in some cases, the first neural network 320 can represent a PointNet network, the second neural network 322 can represent a PointNet and Multilayer Perceptron (MLP) network, the third neural network 324 can represent a PointNet network, the fourth neural network 326 can represent a Transformer Encoder, and the fifth neural network 328 can represent a Multi-Head Attention (MHA) network. In other cases, the first neural network 320, the second neural network 322, the third neural network 324, the fourth neural network 326, and/or the fifth neural network 328 can represent other types of neural network models. In some cases, the output from the fifth neural network 322 can be processed by a sixth neural network, such as an MLP network, that can further process the output from the fifth neural network 322 to generate the output 330, as further described herein.

In some cases, the scene 300 can represent a driving environment of an AV (e.g., AV 302) (e.g., a current scenario). In other words, the scene 300 can represent a real-time environment in which AV 302 is autonomously navigating. In other cases, the scene 300 can represent a driving environment described and/or generated by road data (e.g., sensor data) collected by one or more autonomous vehicles from one or more environments. For example, road data used to generate and/or describe the scene 300 can include sensor data (e.g., LiDAR data, RADAR data, ultrasonic sensor data, IMU data, GNSS data, etc.) collected by one or more AVs, a pose (e.g., pitch, roll, yaw) of the AV 302 in three-dimensional (3D) space, and/or map data of the surrounding environment (e.g., the environment around AV 302).

In some aspects, the trajectory 304 of the AV 302 may be determined by a local computing device (e.g., local computing device 110 illustrated in FIG. 1) of the AV 302 or via instructions from an external source (e.g., instructions received via communications stack 120 as illustrated in FIG. 1). In other words, an external source may define, indicate, and/or instruct the trajectory 304 of the AV 302.

In some examples, there may be one or more samples 306 (e.g., waypoints) of the trajectory 304 which can occur at discrete time intervals (e.g., the location of the AV 302 at consecutive time intervals are samples 306 of the trajectory 304). As illustrated in FIG. 1, the scene 300 may include scene agents 312 and an occluding object 311 that blocks a view of the AV 302 (e.g., a view of one or more sensors of the AV 302) to the occluded scene element 310 such that the AV 302 may not perceive the occluded scene element 310 from a position and perspective of the AV 302. The occluding object 311 may include any object that may occlude (e.g., hide) the occluded scene element 310 from a view of AV 302 and/or prevent the AV 302 (e.g., prevent sensors of the AV 302) from “seeing” the occluded scene element 310 from a position and perspective of the AV 302.

Each scene agent of the one or more scene agents 312 may include, for example and without limitation, a bus, truck, building, structure, vehicle, wall, tree, person, device, sign, and/or any other object. As described herein, the occluded scene element 310 can be a hypothetical occluded scene element that may or may not exist. The dissipation point 307 can represent the moment in space and time where/when the occluded scene element 310 is realized by the AV 302 if the occluded scene element 310 does indeed exist. In other words, for the trajectory 304 of the AV 302, the dissipation point 307 can include the moment in space and time where/when the AV 302 is able to “see” the occluded scene element 310 (e.g., and consequently confirm its existence) or determine that the occluded scene element 310 does not exist (e.g., the AV 302 does not “see” any occluded scene element and/or confirms that there are no scene elements occluded by the occluding object 311).

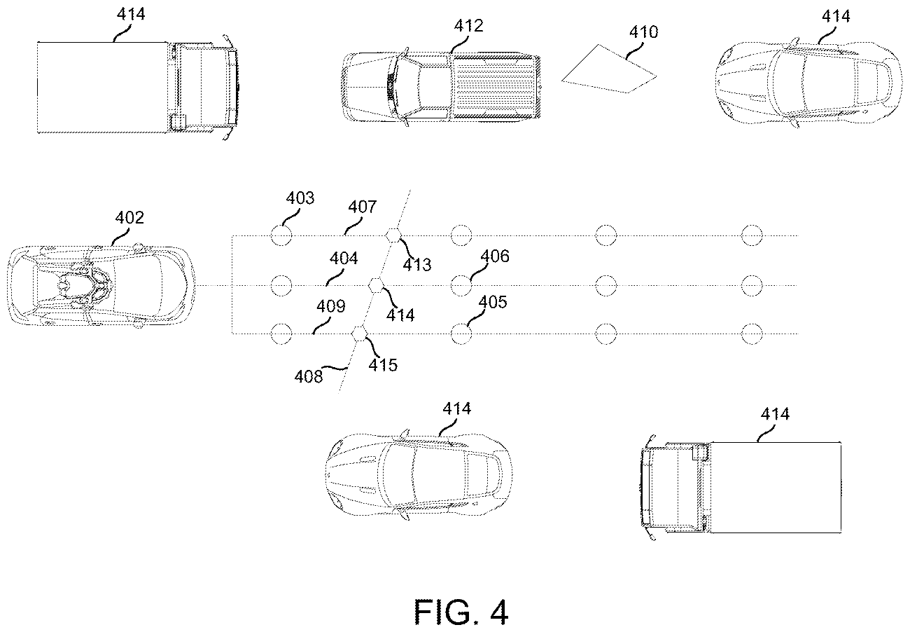

For example, at the dissipation point 307, the occluding object 311 may no longer prevent the AV 302 from “seeing” the occluded scene element 310 if the occluded scene element 310 does indeed exist. Despite the possibility that the occluded scene element 310 may not exist, the AV 302 may assume that the occluded scene element 310 exists to avoid a potential collision with the occluded scene element 310 in the case that the occluded scene element 310 does indeed exist. The occluded scene element 310 may be any object capable of moving such as, for example and without limitation, a human, animal, machine, and/or robot, among others. As a result, the AV 302 can take precautions to avoid a potential collision with the occluded scene element 310. For example, determining the dissipation point 307 may allow the AV 302 to prevent from a potential collision with the occluded scene element 311. A dissipation boundary 308, which will be discussed in further detail below with respect to FIG. 4, may be determined from multiple dissipation points including the dissipation point 307. In some examples, as illustrated in FIG. 3, the trajectory 304 (e.g., and the one or more samples 306 corresponding to the trajectory 304) may be used (e.g., by the neural network(s)) to determine the dissipation point 307, while one or more trajectories may be used determine the dissipation boundary 308. As described herein, in some cases, one or more neural networks (e.g., neural network 200) may be used to determine the dissipation point 307 and the dissipation boundary 308.

In FIG. 3, the first neural network 320 can include a neural network (e.g., neural network 200) configured to receive a first neural network input 316 that may include semantic map information and/or semantic map feature vectors pertaining to the scene 300 where the AV 302 is navigating. Semantic features may include, for example, traffic lights, crosswalks, road signs, traffic lanes, sidewalks, intersections, egress/ingress ramps, and/or other map data that can help the AV 302 to stay in an appropriate lane and/or operate in the environment (e.g., in the scene 300). For example, the first neural network 320 may receive the first neural network input 316 as a vector map of the scene 300 (e.g., a vector map describing the scene 300 and/or portions thereof) and encode it as points and/or values where each point and/or value has its own classification (e.g., traffic light, crosswalk, road sign, traffic lane, intersection, etc.) as determined by the first neural network 320.

The second neural network 322 can include a neural network (e.g., neural network 200) configured and/or trained to receive a second neural network input 317 that includes data relating to the occluded scene element 310 in the scene 300. For example, the second neural network input 317 may include data that describes and/or provides one or more characteristics of the occluded scene element 310 such as, for example and without limitation, the geometry (e.g., size, dimensions) of the occluded scene element 310, the type of object (e.g., pedestrian, animal, vehicle, robotic device, etc.) of the occluded scene element 310, the pose of the occluded scene element 310, etc. In some examples, the second neural network input 317 can also include information relating to the occluding object 311 that is blocking the occluded scene element 310 from a view of the AV 302. For example, in some cases, the second neural network input 317 can include data pertaining to the occluded scene element 310 and the occluding object 311 blocking the occluded scene element 310 from a view of the AV 302. In some cases, the geometry of the occluding object 311 may be correlated as some scene agents (e.g., a tall structure) can have a different impact on the time/location of the dissipation point 307 where/when the AV 302 is able to “see” (e.g., confirm the existence of) the occluded scene element 310 as compared to other scene agents such as a low-profile car or another structure/object that are smaller.

The third neural network 324 can include a neural network (e.g., neural network 200) configured and/or trained to receive a third neural network input 318 that includes data relating to the one or more scene agents 312 and/or the occluding object 311 in the scene 300. For example, the data in the third neural network input 318 can include the geometry (e.g., size, dimension) of the one or more scene agents 312 and/or the occluding object 311, the type of object (e.g., building, structure, tree, vehicle, sign, etc.) of the one or more scene agents 312 and/or the occluding object 311, the pose of the one or more scene agents 312 and/or the occluding object 311, and/or any other data about the one or more scene agents 312 and/or the occluding object 311. In some cases, the data in the third neural network input 318 can include other data used to characterize the one or more scene agents 312 and/or the occluding object 311 in the scene 300.

The system can concatenate the outputs from the first neural network 320, the second neural network 322, and the third neural network 324 into a feature vector 325. For example, the neural networks 320, 322 and 324 can encode each of their respective outputs (e.g., feature vectors), which may then be concatenated into a feature vector 325. In some examples, the feature vector 325 can include and/or provide a representation of the scene 300. For example, the feature vector 325 can include and/or provide a representation of semantic elements of the scene 300 (e.g., traffic lanes, crosswalks, sidewalks, intersections, etc.), the occluded scene element 310, the occluding object 311, and the one or more scene agents 312.

The fourth neural network 326 can include a neural network (e.g., neural network 200) configured and/or trained to receive a fourth neural network input 314 that includes data pertaining to the one or more samples 306 (e.g., waypoints) of the trajectory 304 of the AV 302. For example, the fourth neural network input 314 may include data pertaining to features of each of the one or more samples 306. The fourth neural network 326 can generate a fourth neural network output 327 based on the fourth neural network input 314. The fourth neural network output 327 can augment additional features of each of the one or more samples 306 included in the fourth neural network input 314. Non-limiting examples of features can include pose information (e.g., location, orientation, etc.) of the AV 302, the road characteristics (e.g., curvature, dimensions, inclination, etc.) at each of the one or more samples 306, a distance from each of the one or more samples 306 to the occluded scene element 310, a location of each of the one or more samples 306, etc. In addition, the distance may also be broken down into longitudinal and lateral components. Those skilled in the art will appreciate additional examples of features for the one or more samples 306.

The fifth neural network 328 can include a neural network (e.g., neural network 200) configured and/or trained to receive as input the feature vector 325 (e.g., the concatenated output of the first neural network 320, the second neural network 322, and the third neural network 324) and the fourth neural network output 327 from the fourth neural network 326. In some examples, the fifth neural network 328 can use the feature vector 325, which represents the scene 300 (e.g., data pertaining to the semantic map, the one or more scene agents 312, the occluding object 311, and the occluded scene element 310) that the AV 302 is navigating within, along with each of the one or more samples 306 of the trajectory 304 of the AV 302, to generate an output 330 indicating dissipation information as further described herein. In other words, for each of the one or more samples 306, the fifth neural network 328 may use corresponding scene data (e.g., from feature vector 325) to weigh the importance of each respective sample. For example, a sample of the trajectory 304 that is closer to the dissipation point 307 may be weighed (e.g., via the machine learning algorithms of the neural network) more heavily than a sample from the trajectory 304 that is further way from the dissipation point 307.

In some examples, the output 330 of the fifth neural network 328 may be used to determine a dissipation distance, and the dissipation distance can be used to determine the dissipation point 307. In other words, the dissipation distance may include or indicate the distance that the AV 302 would need to travel to reach the dissipation point 307 (e.g., how far the AV 302 is from the dissipation point 307). Although multiple neural networks have been discussed to determine the dissipation point 307 and the dissipation distance, in some cases a single neural network may also be used (e.g., instead of five neural networks as illustrated in FIG. 3). Thus, in other examples, the operations performed with respect to FIG. 3 may be performed using more or less neural networks than the neural networks shown in FIG. 3. Moreover, in some examples, the neural networks shown in FIG. 3 may be part of a same or single, larger neural network or may be separate neural networks.

FIG. 4 is a diagram illustrating an example system for determining a dissipation boundary, according to some examples of the present disclosure. The system includes an AV 402, a first trajectory 404, a second trajectory 407, a third trajectory 409, one or more first trajectory waypoints 406 (e.g., samples), one or more second trajectory waypoints 403 (e.g., samples), one or more third trajectory waypoints 405 (e.g., samples), a first dissipation point 414, a second dissipation point 413, a third dissipation point 415, a dissipation boundary 408, one or more hypothetical occluded scene elements 410, an occluding object 412, and one or more scene agents 414.

As illustrated, the AV 402 may be unable to perceive or “see” (e.g., via sensor systems 104, 106 and 108) the hypothetical occluded scene element 410 due to occluding object 412 as the occluding object 412 is positioned relative to the AV 402 and the hypothetical occluded scene element 410 such that it may block a view from the AV 402 to the hypothetical occluded scene element 410. There may be a moment in space and time for a given trajectory of the AV 402 where/when the hypothetical occluded scene element 410 is realized or determined to exist or not exist by the AV 402. In other words, as the AV 402 travels along a trajectory, there may be a moment in space and time where/when the AV 402 can “see” the hypothetical occluded scene element 410 and it is no longer occluded from view by occlusion 412. For a given trajectory, this moment in space and time may be referred to as a dissipation point.

As illustrated in FIG. 3, the first neural network 320, second neural network 322, third neural network 324, fourth neural network 326 and fifth neural network 328 may be used to determine a dissipation point 307 for a given trajectory, as previously explained. In some examples, more than one trajectory may be used by the neural networks to determine multiple dissipation points as discussed in FIG. 3, which may be used to generate or determine a dissipation boundary (e.g., dissipation boundary 408). For example, the first trajectory 404 and corresponding one or more waypoints 406 can be used by the neural network(s) to determine the first dissipation point 414.

The AV 402 may navigate another trajectory such as the second trajectory 407. The second trajectory 407 and the corresponding one or more waypoints 403 may be used by the neural network(s) to determine a second dissipation point 413. The third trajectory 409 can be another example trajectory that the AV 402 may navigate/take. Thus, the third trajectory 409 and the corresponding one or more waypoints 405 may be used by the neural network(s) to determine a third dissipation point 415. Although three trajectories are illustrated in FIG. 4, in other examples, there may be more or less trajectories used to determine respective dissipation points.

The dissipation points 413, 414 and 415 may be used by the neural network(s) to determine a dissipation boundary 408. For example, one or more neural networks as illustrated in FIG. 3 may use the dissipation points 413, 414 and 415 to determine the dissipation boundary 408, as previously explained. In some cases, the dissipation boundary 408 can represent a boundary, line, outline, etc., along the dissipation points 413, 414 and 415 and/or connecting the dissipation points 413, 414 and 415. The AV 402 can use the dissipation boundary 408 to determine a moment in time and space when the AV 402 can expect to perceive the hypothetical occluded scene element 410, if it indeed exists. Accordingly, the AV 402 can use the dissipation boundary 408 to proactively react and/or plan how to act in view of the potential that the hypothetical occluded scene element 410 exists and/or may not be perceived by the AV 402 until the AV 402 reaches the dissipation boundary 408.

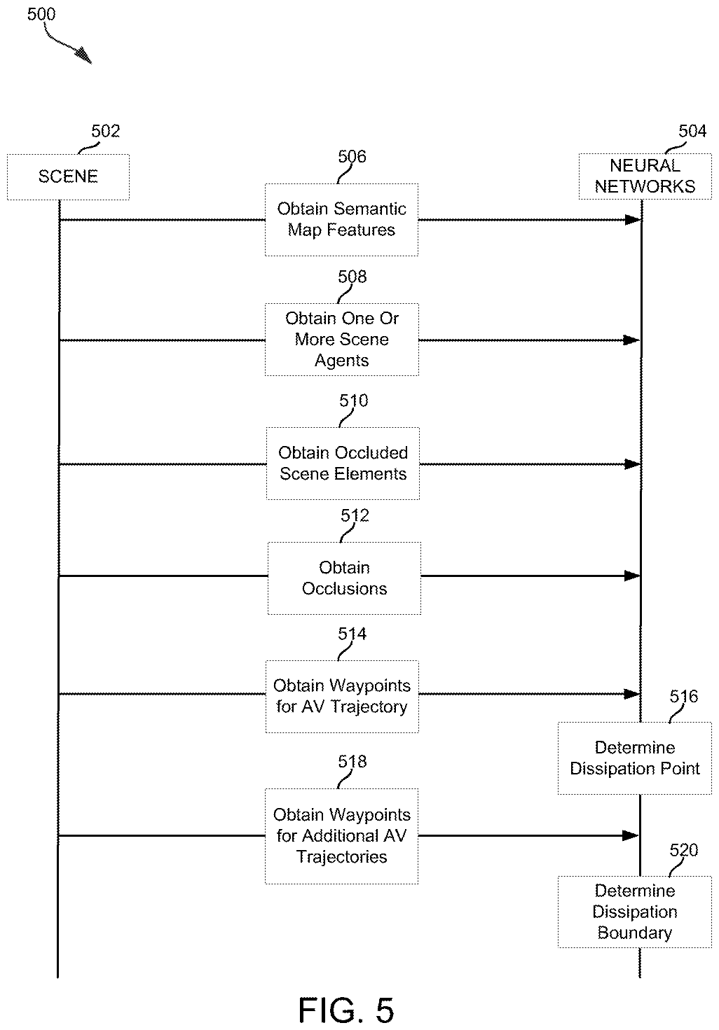

FIG. 5 illustrates an example process 500 for determining a dissipation boundary (e.g., by one or more neural networks 504) for a scene 502, according to some examples of the present disclosure. In some aspects, the scene 502 may represent a real-world environment in which an AV is navigating. In other aspects, the scene 502 may be constructed from stored road data collected by AV sensors in a real-world environment. Such road data can record what the AV “saw” while navigating in a real-world environment.

The one or more neural networks 504 may be the same or different than the neural networks illustrated in FIG. 4 (e.g., neural networks 320, 322, 324, 326 and 328). In some cases, the one or more neural networks 504 may be implemented by a data center (e.g., data center 150), an external/remote computing device, or a local computing device of an AV (e.g., local computing device 110).

At block 506, the process 500 can include obtaining semantic map features associated with the scene 502. For example, the one or more neural networks 504 can determine and/or extract semantic data (e.g., traffic lights, crosswalks, road signs, traffic lanes and/or lane positions, intersections, egress/ingress ramps, etc.) from data corresponding to (e.g., representing and/or describing) the scene 502. In some examples, the one or more neural networks 504 can determine the semantic data from road data obtained from one or more real-world environments.

At block 508, the process 500 can include obtaining scene agents located in the scene 502. For example, the neural network 324 can receive data relating to (e.g., one or more scene agents 312) one or more scene agents in the scene. In some cases, the data relating to the one or more scene agents in the scene can include the geometry (e.g., size, dimension) of the one or more scene agents, the type of object (e.g., building, structure, tree, vehicle, sign, etc.) of the one or more scene agents, the pose of the one or more scene agents, and/or any other data about the one or more scene agents. In some cases, the data relating to the one or more scene agents can include other data used to characterize the one or more scene agents in the scene.

In some examples, the one or more scene agents can include other vehicles, bicycles, motorcycles, and/or any other object, system, and/or platform for transporting people and/or goods. In some cases, the one or more scene agents can additionally or alternatively include other objects such as, for example and without limitation, one or more buildings, structures, trees, signs, benches, construction objects, etc.

At block 510, the process 500 can include obtaining occluded scene elements pertaining to the scene 502. For example, the one or more neural networks 504 determine and/or extract the one or more occluded scene elements from data associated with the scene 502 (e.g., sensor data describing and/or representing the scene 502). In some examples, the one or more occluded scene elements can include objects in the scene 502 that may or may not exist and that may be occluded from a view of the AV in the scene 502 by an occluding object (e.g., another vehicle, a structure, a tree, a building, a sign, etc.). In some cases, the AV may use a local computing device 110 and perception stack 112 of the AV to determine a probability of the existence of the one or more occluded scene elements in the scene 502.

In some cases, obtaining occluded scene elements can include determining data pertaining to the occluded scene elements. Such data may include, for example and without limitation, a type of the occluded scene element (e.g., a pedestrian, an animal, a vehicle, a bicycle, etc.), a pose of the occluded scene element, a dimension(s) of the occluded scene element, etc.

At block 512, the process 500 can include obtaining occlusion data pertaining to an occluding object blocking the occluded scene element from a view of the AV. The occlusion data may include, for example and without limitation, a geometry of the occluding object, a dimension(s) of the occluding object, a type of the occluding object (e.g., a structure, a vehicle, a tree, a building, etc.), a pose of the occluding object, etc.

At block 514, the process 500 can include obtaining waypoints for an AV trajectory (e.g., a trajectory of the AV within the scene 502). For example, the AV can have a trajectory (e.g., trajectory 304) with a series of discrete time samples (e.g., samples 306) which can represent moments in space and time where/when the AV is in the scene 502. The trajectory of the AV may be determined by the AV itself (e.g., via local computing device 110) or from instructions received (e.g., via communications stack 120) from an external source(s).

At block 516, the process 500 can include determining a dissipation point associated with the occluded object. In some examples, the AV can determine the dissipation point based on the semantic features from block 506, the one or more scene agents from block 508, the scene elements from block 510, the occlusion data from block 512, and/or the waypoints from block 514. In some examples, the dissipation point can include, for a given trajectory of the AV, a moment in space and time where/when the occluded scene element (e.g., from block 510) is realized (e.g., determined to exist or not exist) by the AV. In other words, the dissipation point can include a moment in time and space where/when the occluding object is no longer blocking the occluded scene element from a view of the AV. The one or more neural networks 504 may use the data from blocks 506, 508, 510, 512, and/or 514 to determine the dissipation point, as previously explained.

At block 518, the process 500 can include determining (e.g., by the one or more neural networks 504) one or more waypoints for one or more additional AV trajectories. For example, the AV may have additional trajectories available as possible trajectories within the scene 502. Accordingly, the one or more neural networks 504 may determine respective dissipation points corresponding to the one or more additional trajectories.

At block 520, the process 500 can include determining a dissipation boundary associated with the occluded scene element. In some examples, the AV can determine the dissipation boundary by combining and/or connecting (e.g., via a straight or curved line) the one or more dissipation points from the one or more trajectories associated with the scene 502.

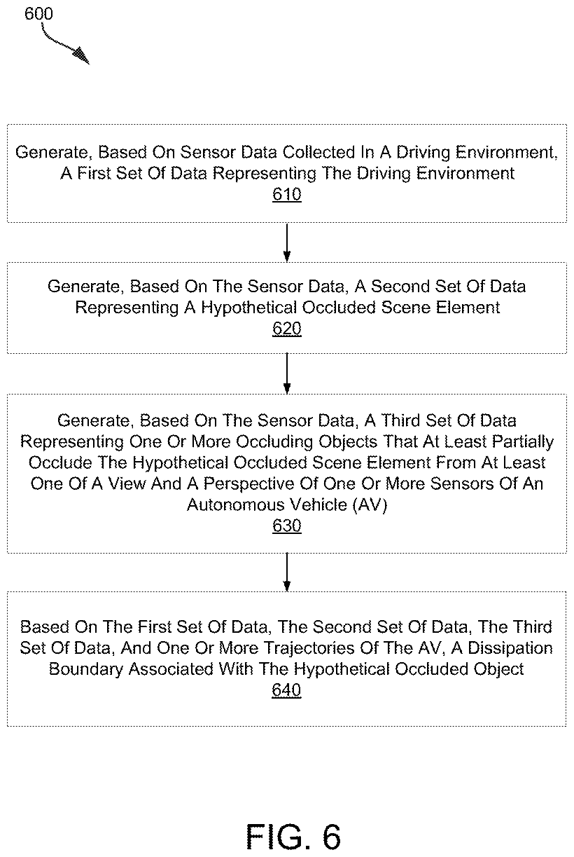

FIG. 6 illustrates an example process for determining a dissipation boundary, according to some aspects of the present disclosure. At block 610, the process 600 includes generating, based on sensor data collected in a driving environment (e.g., scene 300), a first set of data representing the driving environment. For example, a neural network (e.g., first neural network 320) can use the sensor data to determine and/or generate a set of semantic data or semantic features associated with the driving environment.

In some examples, the first set of data can include one or more semantic map feature vectors. The one or more semantic map feature vectors can correspond to one or more scene elements in the driving environment. The one or more scene elements can include, for example and without limitation, an intersection, a traffic lane, a crosswalk, and a roadway ramp.

At block 620, the process 600 includes generating, based on the sensor data, a second set of data representing a hypothetical occluded scene element in the driving environment. For example, a neural network (e.g., second neural network 322) can use the sensor data to determine and/or generate data (e.g., data 317) describing and/or representing aspects (e.g., geometry, location, type, pose, etc.) of the hypothetical occluded scene element.

The second set of data can include data indicating a location of the hypothetical occluded scene element, a pose of the hypothetical occluded scene element, one or more dimensions of the hypothetical occluded scene element, and/or a type of object of the hypothetical occluded scene element.

At block 630, the process 600 includes generating, based on the sensor data, a third set of data representing one or more occluding objects that at least partially occlude the hypothetical occluded scene element from a view and/or a perspective of one or more sensors of an AV in the driving environment. For example, a neural network (e.g., third neural network 324) can use the sensor data to determine aspects (e.g., geometry, location, type, pose, etc.) of the hypothetical occluded scene element.

In some examples, the third set of data can include data indicating a location of the one or more occluding objects, a pose of the one or more occluding objects, one or more dimensions of the one or more occluding objects, and/or a type of object of the one or more occluding objects. In some cases, the third set of data can additional represent (e.g., describe, characterize, identify, etc.) one or more scene agents in the driving environment.

At block 640, the process 600 includes based on the first set of data, the second set of data, the third set of data, and one or more trajectories of an AV in the driving environment, determining a dissipation boundary associated with the hypothetical occluded scene element. In some examples, the dissipation boundary can include one or more locations where the AV is predicted to perceive the hypothetical occluded scene element.

In some examples, the dissipation boundary can include one or more dissipation points. Each of the one or more dissipation points can correspond to a respective trajectory from a plurality of trajectories of the AV. Moreover, the plurality of trajectories can include the one or more trajectories of the AV.

In some examples, the fourth set of data can include one or more sampled points from the one or more trajectories of the AV.

FIG. 7 illustrates an example processor-based system with which some aspects of the subject technology can be implemented. For example, processor-based system 700 can be any computing device making up local computing device 110, client computing device 170, a passenger device executing the ridesharing application 172, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some examples, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (CPU or processor) 710 and connection 705 that couples various system components including system memory 715, such as read-only memory (ROM) 720 and random-access memory (RAM) 725 to processor 710. Computing system 700 can include a cache of high-speed memory 712 connected directly with, in close proximity to, and/or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 can include an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L #), resistive random-access memory (RRAM/ReRAM), phase change memory (PCM), spin transfer torque RAM (STT-RAM), another memory chip or cartridge, and/or a combination thereof.

Storage device 730 can include software services, servers, virtual machines, software containers, applications, etc., which, when the code of such software services, servers, virtual machines, software containers, applications, etc., is executed by the processor 710, causes the system to perform a function. In some examples, a hardware service that performs a particular function can include the software component stored in a computer-readable medium in connection with the necessary hardware components, such as processor 710, connection 705, output device 735, etc., to carry out the function.

As understood by those of skill in the art, machine-learning techniques can vary depending on the desired implementation. For example, machine-learning schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the example aspects and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: at least one memory; and at least one processor coupled to the at least one memory, the at least one processor configured to: generate, based on sensor data collected in a driving environment, a first set of data representing the driving environment; generate, based on the sensor data, a second set of data representing a hypothetical occluded scene element in the driving environment; generate, based on the sensor data, a third set of data representing one or more occluding objects that at least partially occlude the hypothetical occluded scene element from at least one of a view and a perspective of one or more sensors of an autonomous vehicle (AV) in the driving environment; and based on the first set of data, the second set of data, the third set of data, and one or more trajectories of the AV, determine a dissipation boundary associated with the hypothetical occluded scene element, wherein the dissipation boundary comprises one or more locations where the AV is predicted to perceive the hypothetical occluded scene element.

Aspect 2. The system of Aspect 1, wherein the first set of data comprises one or more semantic map feature vectors.

Aspect 3. The system of Aspect 2, wherein the one or more semantic map feature vectors corresponds to one or more scene elements in the driving environment, the one or more scene elements comprising at least one of an intersection, a traffic lane, a crosswalk, and a roadway ramp.

Aspect 4. The system of any of Aspects 1 to 3, wherein the second set of data comprises data indicating at least one of a location of the hypothetical occluded scene element, a pose of the hypothetical occluded scene element, one or more dimensions of the hypothetical occluded scene element, and a type of object of the hypothetical occluded scene element.

Aspect 5. The system of any of Aspects 1 to 4, wherein the third set of data comprises data indicating at least one of a location of the one or more occluding objects, a pose of the one or more occluding objects, one or more dimensions of the one or more occluding objects, and a type of object of the one or more occluding objects.

Aspect 6. The system of any of Aspects 1 to 5, wherein the dissipation boundary comprises one or more dissipation points, and wherein each of the one or more dissipation points corresponds to a respective trajectory from a plurality of trajectories of the AV, the plurality of trajectories comprising the one or more trajectories of the AV.

Aspect 7. The system of any of Aspects 1 to 6, wherein the fourth set of data comprises one or more sampled points from the one or more trajectories of the AV.

Aspect 8. A method comprising: generating, based on sensor data collected in a driving environment, a first set of data representing the driving environment; generating, based on the sensor data, a second set of data representing a hypothetical occluded scene element in the driving environment; generating, based on the sensor data, a third set of data representing one or more occluding objects that at least partially occlude the hypothetical occluded scene element from at least one of a view and a perspective of one or more sensors of an autonomous vehicle (AV) in the driving environment; and based on the first set of data, the second set of data, the third set of data, and one or more trajectories of the AV, determining a dissipation boundary associated with the hypothetical occluded scene element, wherein the dissipation boundary comprises one or more locations where the AV is predicted to perceive the hypothetical occluded scene element.

Aspect 9. The method of Aspect 8, wherein the first set of data comprises one or more semantic map feature vectors.

Aspect 10. The method of Aspect 9, wherein the one or more semantic map feature vectors correspond to one or more scene elements in the driving environment, the one or more scene elements comprising at least one of an intersection, a traffic lane, a crosswalk, and a roadway ramp.

Aspect 11. The method of any of Aspects 8 to 10, wherein the second set of data comprises data indicating of at least one of a location of the hypothetical occluded scene element, a pose of the hypothetical occluded scene element, one or more dimensions of the hypothetical occluded scene element, and a type of object of the hypothetical occluded scene element.

Aspect 12. The method of any of Aspects 8 to 11, wherein the third set of data comprises data indicating at least one of a location of the one or more occluding objects, a pose of the one or more occluding objects, one or more dimensions of the one or more occluding objects, and a type of object of the one or more occluding objects.

Aspect 13. The method of any of Aspects 8 to 12, wherein the dissipation boundary comprises one or more dissipation points, and wherein each of the one or more dissipation points corresponds to a respective trajectory from a plurality of trajectories of the AV, the plurality of trajectories comprising the one or more trajectories of the AV.

Aspect 14. The method of any of Aspects 8 to 13, wherein the fourth set of data comprises one or more sampled points from the one or more trajectories of the AV.

Aspect 15. A non-transitory computer-readable storage medium comprising instructions which, when executed by one or more processors, cause the one or more processors to perform a method according to any of Aspects 8 to 14.

Aspect 16. A system comprising means for performing a method according to any of Aspects 8 to 14.

Aspect 17. A computer-program product having stored thereon instructions which, when executed by one or more processors, cause the one or more processors to perform a method according to any of Aspects 8 to 14.

Aspect 18. An autonomous vehicle comprising a computer system comprising memory and one or more processors, the one or more processors configured to perform a method according to any of Aspects 8 to 14.

What is claimed is:

1. A system comprising:
at least one memory; and
at least one processor coupled to the at least one memory, the at least one processor configured to:
generate, based on sensor data collected in a driving environment, a first set of data representing the driving environment;
generate, based on the sensor data, a second set of data representing a hypothetical occluded scene element in the driving environment;
generate, based on the sensor data, a third set of data representing one or more occluding objects that at least partially occlude the hypothetical occluded scene element from at least one of a view and a perspective of one or more sensors of an autonomous vehicle (AV) in the driving environment; and
based on the first set of data, the second set of data, the third set of data, and one or more trajectories of the AV, determine a dissipation boundary associated with the hypothetical occluded scene element, wherein the dissipation boundary comprises one or more locations where the AV is predicted to perceive the hypothetical occluded scene element.

2. The system of claim 1, wherein the first set of data comprises one or more semantic map feature vectors.

3. The system of claim 2, wherein the one or more semantic map feature vectors corresponds to one or more scene elements in the driving environment, the one or more scene elements comprising at least one of an intersection, a traffic lane, a crosswalk, and a roadway ramp.

4. The system of claim 1, wherein the second set of data comprises data indicating at least one of a location of the hypothetical occluded scene element, a pose of the hypothetical occluded scene element, one or more dimensions of the hypothetical occluded scene element, and a type of object of the hypothetical occluded scene element.

5. The system of claim 1, wherein the third set of data comprises data indicating at least one of a location of the one or more occluding objects, a pose of the one or more occluding objects, one or more dimensions of the one or more occluding objects, and a type of object of the one or more occluding objects.

6. The system of claim 1, wherein the dissipation boundary comprises one or more dissipation points, and wherein each of the one or more dissipation points corresponds to a respective trajectory from a plurality of trajectories of the AV, the plurality of trajectories comprising the one or more trajectories of the AV.

7. The system of claim 1, wherein the fourth set of data comprises one or more sampled points from the one or more trajectories of the AV.

8. A method comprising:
generating, based on sensor data collected in a driving environment, a first set of data representing the driving environment;
generating, based on the sensor data, a second set of data representing a hypothetical occluded scene element in the driving environment;
generating, based on the sensor data, a third set of data representing one or more occluding objects that at least partially occlude the hypothetical occluded scene element from at least one of a view and a perspective of one or more sensors of an autonomous vehicle (AV) in the driving environment; and
based on the first set of data, the second set of data, the third set of data, and one or more trajectories of the AV, determining a dissipation boundary associated with the hypothetical occluded scene element, wherein the dissipation boundary comprises one or more locations where the AV is predicted to perceive the hypothetical occluded scene element.

9. The method of claim 8, wherein the first set of data comprises one or more semantic map feature vectors.

10. The method of claim 9, wherein the one or more semantic map feature vectors correspond to one or more scene elements in the driving environment, the one or more scene elements comprising at least one of an intersection, a traffic lane, a crosswalk, and a roadway ramp.

11. The method of claim 8, wherein the second set of data comprises data indicating of at least one of a location of the hypothetical occluded scene element, a pose of the hypothetical occluded scene element, one or more dimensions of the hypothetical occluded scene element, and a type of object of the hypothetical occluded scene element.

12. The method of claim 8, wherein the third set of data comprises data indicating at least one of a location of the one or more occluding objects, a pose of the one or more occluding objects, one or more dimensions of the one or more occluding objects, and a type of object of the one or more occluding objects.

13. The method of claim 8, wherein the dissipation boundary comprises one or more dissipation points, and wherein each of the one or more dissipation points corresponds to a respective trajectory from a plurality of trajectories of the AV, the plurality of trajectories comprising the one or more trajectories of the AV.

14. The method of claim 8, wherein the fourth set of data comprises one or more sampled points from the one or more trajectories of the AV.

15. A non-transitory computer-readable storage medium comprising instructions which, when executed by one or more processors, cause the one or more processors to:
generate, based on sensor data collected in a driving environment, a first set of data representing the driving environment;
generate, based on the sensor data, a second set of data representing a hypothetical occluded scene element in the driving environment;
generate, based on the sensor data, a third set of data representing one or more occluding objects that at least partially occlude the hypothetical occluded scene element from at least one of a view and a perspective of one or more sensors of an autonomous vehicle (AV) in the driving environment; and
based on the first set of data, the second set of data, the third set of data, and one or more trajectories of the AV, determine a dissipation boundary associated with the hypothetical occluded scene element, wherein the dissipation boundary comprises one or more locations where the AV is predicted to perceive the hypothetical occluded scene element.

16. The non-transitory computer-readable storage medium of claim 15, wherein the first set of data comprises one or more semantic map feature vectors.

17. The non-transitory computer-readable storage medium of claim 16, wherein the one or more semantic map feature vectors correspond to one or more scene elements in the driving environment, the one or more scene elements comprising at least one of an intersection, a traffic lane, a crosswalk, and a roadway ramp.

18. The non-transitory computer-readable storage medium of claim 15, wherein the second set of data comprises data indicating of at least one of a location of the hypothetical occluded scene element, a pose of the hypothetical occluded scene element, one or more dimensions of the hypothetical occluded scene element, and a type of object of the hypothetical occluded scene element.

19. The non-transitory computer-readable storage medium of claim 15, wherein the third set of data comprises data indicating at least one of a location of the one or more occluding objects, a pose of the one or more occluding objects, one or more dimensions of the one or more occluding objects, and a type of object of the one or more occluding objects.

20. The non-transitory computer-readable storage medium of claim 15, wherein the dissipation boundary comprises one or more dissipation points, and wherein each of the one or more dissipation points corresponds to a respective trajectory from a plurality of trajectories of the AV, the plurality of trajectories comprising the one or more trajectories of the AV.
